(19) United States
(12) Patent Application Publication
(10) Pub. No.: US 2008/0279405 A1
(43) Pub. Date: Nov. 13, 2008

(54) In-The-Ear Hearing Aid

(75) Inventors: Takatoshi Isogi, Tokyo (JP); Toshiyuki Araki, Tokyo (JP)

Correspondence Address: LEE FREDRIC SHARRA, 4313 TROUTHAVEN DRIVE, MURRYSVILLE, PA, 15668, US

(73) Assignee: RION CO., LTD., Tokyo (JP)

(21) Appl. No.: 12/158,769

(22) PCT Filed: Dec. 28, 2005
(86) PCT No.: PCT/JP2005/024094

§ 371 Date: Jun. 23, 2008

(51) Int. Cl. H04R 25/02

(52) U.S. Cl. 381/329

(57) ABSTRACT

In an in-the-ear hearing aid provided with a pull-out type linear member, a housing section is provided to house a pull-out type linear member 25. The housing section is a guide tunnel 24 penetrating a case body 23. The pull-out type linear member 25 is provided, at both ends, with small bulges 25a and 25b. The pull-out type linear member 25 is provided in such a manner that the front small bulge 25b is located outside the guide tunnel 24 and the rear small bulge 25a is located inside the guide tunnel 24. A small diameter port 24a is provided at an opening section of the guide tunnel 24 to serve as a stopper for the rear small bulge 25a.

### BACKGROUND OF THE INVENTION

1. Field of the Invention

The present invention relates to an in-the-ear hearing aid provided with a pull-out type linear member (pull-out nylon string) for removing the in-the-ear hearing aid fitted into an external auditory canal.

2. Description of the Prior Art

An in-the-ear hearing aid of a type which is snugly fitted into an external auditory canal is provided with a pull-out type linear member adapted to be gripped and pulled when removed from the external auditory canal. This pull-out type linear member is generally installed in a location where operation of a surface of a face plate which constitutes a hearing aid case is not hindered. A method for attaching the pull-out type linear member to the face plate comprises the steps of making a through-hole in the face plate, inserting a resin-made linear member into the through-hole, providing an end of the linear member inserted inside the face plate with a small bulge, and causing the small bulge to adhere to an inner wall surface of the face plate using an adhesive agent and the like (for example, refer to Patent Document 1).

Patent Document 1: Japanese Patent Application Publication No. 2002-260617

However, in the pull-out type linear member of an in-the-ear hearing aid disclosed in Patent Document 1, even though the hearing aid itself is fitted into and concealed from the external auditory canal, there are some cases where the pull-out type linear member appears to protrude from an external auditory canal and looks unattractive. Further, a pain may be felt when the pull-out type linear member which has protruded from the external auditory canal touches an auricle of ear. In the case where the in-the-ear hearing aid is removed from the external auditory canal, the pull-out type linear member is gripped by the fingertips. In this case, there are also some cases where the pull-out type linear member will break off because load is applied to the base of the pull-out type linear member adhering to the face plate or the small bulge within the hearing aid case is removed or has fallen off.

In order to repair such a pull-out type linear member, it is necessary to remove the face plate adhering to a shell, reattach the pull-out type linear member to the face plate, and affix the face plate again to the shell. In this manner, the operation becomes very complicated.

### SUMMARY OF THE INVENTION

It is therefore an object of the present invention to solve the problems seen in the prior art and to provide an in-the-ear hearing aid which looks good when fitted in the ear and of which the pull-out type linear member can be readily repaired and replaced.

In order to attain this object, according to a first aspect of the present invention, an in-the-ear hearing aid provided with a pull-out type linear member is provided, in which a housing section is provided to house the pull-out type linear member.

According to a second aspect of the present invention, the in-the-ear hearing aid of the first aspect is provided, in which the housing section is a tube member disposed within a case body.

According to a third aspect of the present invention, the in-the-ear hearing aid of the first aspect is provided, in which the housing section is the tube member disposed inside the case body and a guide groove formed on the inner wall surface of the case body.

According to a fourth aspect of the present invention, the in-the-ear hearing aid of the first aspect is provided, in which the housing section is a guide tunnel penetrating the case body.

According to a fifth aspect of the present invention, the in-the-ear hearing aid of the first aspect is provided, in which the housing section is the guide tunnel formed on the case body and a vent port adapted to communicate with the guide tunnel.

According to a sixth aspect of the present invention, the in-the-ear hearing aid of the first, second, third, fourth or fifth aspect is provided, in which the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

According to a seventh aspect of the present invention, the in-the-ear hearing aid of the sixth aspect is provided, in which the rear small bulge is composed of a magnetic member and a hall element is provided in the vicinity of the housing section.

According to an eighth aspect of the present invention, an in-the-ear hearing aid provided with a pull-out type linear member is provided, in which the pull-out type linear member is fitted into an openable and closable battery holder.

According to a ninth aspect of the present invention, the in-the-ear hearing aid provided with the pull-out type linear member is provided, in which the pull-out type linear member is mounted on a rotational axis with which the openable and closable battery holder is adapted to engage.

### BRIEF DESCRIPTION OF THE DRAWINGS

The above and other objects, features and advantages of the present invention will become more apparent from the following description when taken in conjunction with the accompanying drawings.

FIG. 1 is shows a first embodiment of an in-the-ear hearing aid according to the present invention, wherein (a) is an entire perspective view, (b) is a cross-sectional view of an essential part, and (c) is a perspective view of a tube member;

FIG. 2 shows a second embodiment of an in-the-ear hearing aid according to the present invention, wherein (a) is an entire perspective view, (b) is a cross-sectional view of an essential part, (c) is a cross-sectional view taken along line A-A of FIG. 2 (a), and (d) is a cross-sectional view taken along line B-B of FIG. 2 (a);

FIG. 3 shows a third embodiment of an in-the-ear hearing aid according to the present invention, wherein (a) is a entire perspective view, (b) is a cross-sectional view of an essential part, and (c) is a cross-sectional view of an essential part of another embodiment;

FIG. 4 shows a fourth embodiment of an in-the-ear hearing aid according to the present invention, wherein (a) is an entire perspective view and (b) is a cross-sectional view of an essential part;

FIG. 5 is a cross-sectional view of an essential part of a fifth embodiment of an in-the-ear hearing aid according to the present invention;

FIG. 6 show a sixth embodiment of an in-the-ear hearing aid according to the present invention, wherein (a) is an entire perspective view, (b) is a cross-sectional view of a pull-out type linear member, (c) is a front view of a battery holder, and (d) is a cross-sectional view taken along line C-C of FIG. 6 (c);

FIG. 7 shows a seventh embodiment of an in-the-ear hearing aid according to the present invention, wherein (a) is an entire perspective view and (b) is a cross-sectional view of a battery holder;

FIG. 8 shows an eighth embodiment of an in-the-ear hearing aid according to the present invention, wherein (a) is an entire perspective view and (b) is a cross-sectional view of an essential part; and

FIG. 9 is an entire perspective view of a ninth embodiment of an in-the-ear hearing aid according to the present invention.

### DETAILED DESCRIPTION OF THE PREFERRED EMBODIMENTS

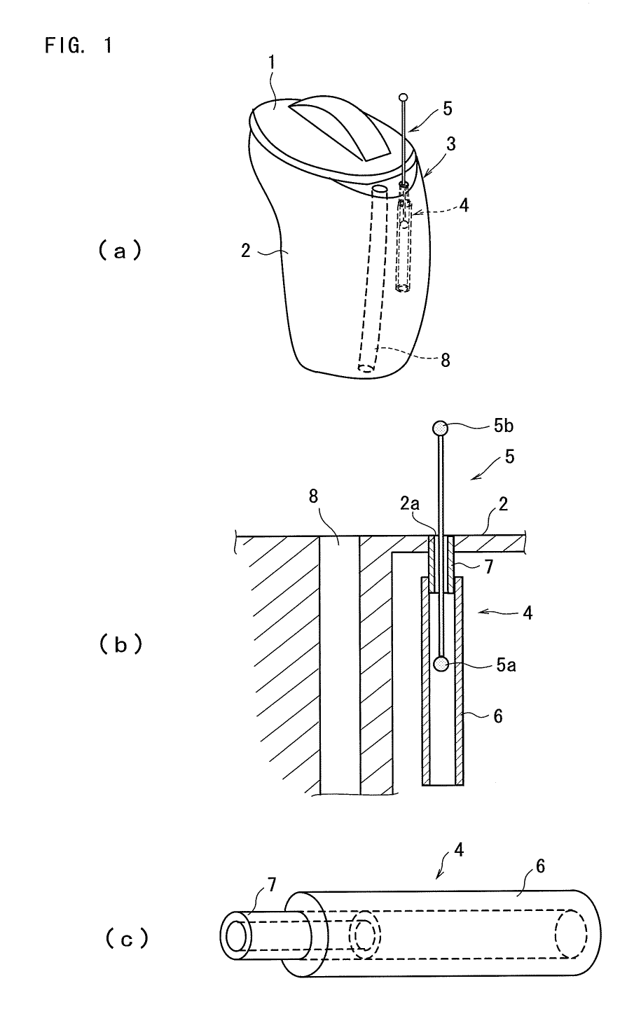

A preferred embodiment of the present invention will now be described with reference to the accompanying drawings. FIGS. 1 through 9 are explanatory views of first through ninth embodiments of an in-the-ear hearing aid according to the present invention.

Referring to a first embodiment of the present invention, as shown in FIG. 1(a), a case body 3 is composed of a face plate 1 and a shell 2. A tube member 4 is disposed within the case body 3 and as shown in FIG. 1(b), a pull-out type linear member 5 is inserted into the tube member 4. Housed within the case body 3 are an amplifier or a DSP, a microphone, an earphone, and a button battery (not shown). The face plate 1 and the shell 2 are affixed to form the case body 3, but in the case where the instruments such as the microphone and the amplifier housed within the case body 3 are repaired, the face plate 1 can be removed from the shell 2.

The face plate 1 is a plate-shaped member made of resin and is provided with an opening for housing a battery holder, a through-hole for installing the microphone, and the like. The face plate 1 can also be selectively provided with a volume switch and a connector for connecting it to a personal computer and the like depending upon the type of hearing aid. An edge section of the face plate 1 is trimmed to meet the shape of the shell 2 so that the boundary of the face plate with the shell 2 becomes smooth.

The shell 2 is made by a stereolithography based on an auriculate (shape of ear) collected from an individual wearer. Since the shape of the shell 2 made here depends upon shell shape data made on a computer, any form can be made simply by making the desired data.

The tube member 4 is composed, as shown in FIG. 1(c), of a large diameter resin tube 6 (e.g., inner diameter: 1.5 mm; outer diameter: 2 mm; length: 10 mm) and a small diameter resin tube 7 (e.g., inner diameter: 0.6 mm; outer diameter: 1.3 mm; length: 5 mm). One end of the small diameter resin tube 7 is inserted into one end of the large diameter resin tube 6, while the other end of the small diameter resin tube 7 is fitted into an opening section 2a formed in the shell 2. The opening section 2a is a through-hole for establishing communication between the inside of the case body 3 and the outer world. Further, the other end of the small diameter resin tube 7 is trimmed to copy the surface shape of the shell 2. The large diameter resin tube 6 is disposed along a vent port 8 for establishing communication between a space within an external auditory canal and the outer world when the hearing aid is used.

The pull-out type linear member 5 is, as shown in FIG. 1(b), a resin-made linear member (e.g., nylon series) with a diameter of about 0.5 mm and is provided at both ends with small lumps 5a and 5b. The pull-out type linear member 5 is inserted into the tube member 4 before the face plate 1 is affixed to the shell 2. The outer diameter of the small bulges 5a, 5b is larger than the inner diameter of the small diameter resin tube 7 to prevent the pull-out type linear member 5 from coming off the tube member 4. The small diameter resin tube 7 also serves as a stopper for the small bulge 5a.

In order to insert the pull-out type linear member 5 into the tube member 4, the linear member is first inserted into the tube member 4 attached to the shell 2 through the opening section 2a side of the shell 2 to project from the other end of the large diameter resin tube 6. An end section of the projected linear member is melted by a soldering iron to form the small bulge 5a and then the linear member is pulled until the small bulge 5a touches one end of the small diameter resin tube 7. In a condition in which the small bulge 5a touches one end of the small diameter resin tube 7, the linear member is cut in a desired length, wherein a bead is affixed to the cut end section to form the small bulge 5b. The length of the pull-out type linear member 5 is determined so that the small bulge 5a does not project from the other end of the large diameter resin tube 6 when the pull-out type linear member 5 is pushed into the tube member 4.

By providing such a pull-out type linear member 5, when the in-the-ear hearing aid is not used, the pull-out type linear member 5 is brought into the projecting condition. By gripping the pull-out type linear member 5 by the fingertips, the entire in-the-ear hearing aid can be held. This makes removal of the hearing aid easy. On the other hand, when the hearing aid is used, by pushing the pull-out type linear member 5 into the tube member 4 to be housed therein, the pull-out type linear member 5 is hidden from the eyes of an onlooker and the hearing aid has an attractive appearance.

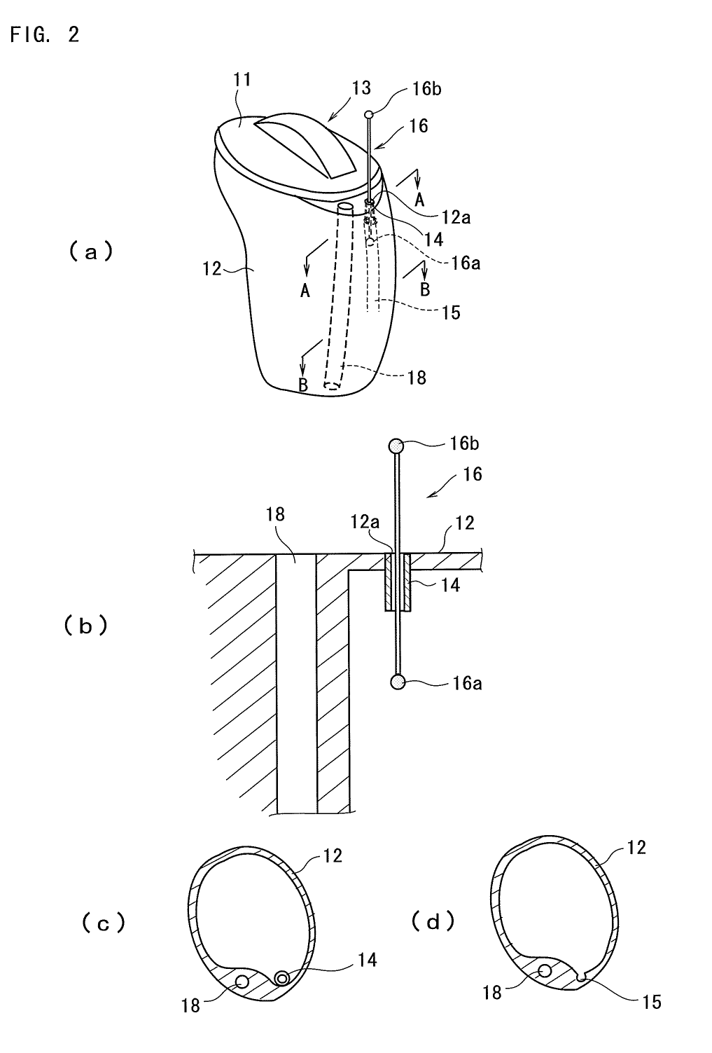

A second embodiment of the in-the-ear hearing aid according to the present invention is shown in FIG. 2. A case body 13 is composed of a face plate 11 and a shell 12. A tube member 14 is disposed within the case body 13 and a guide groove 15 is formed on the inner wall surface of the shell 12. A pull-out type linear member 16 is inserted into the tube member 14. The face plate 11 and the shell 12 are affixed to form the case body 13, but in the case where instruments such as a microphone and an amplifier housed within the case body 13 are repaired, the face plate 11 can be removed from the shell 12. Since parts other than the shell 12 and a housing section are the same as in the first embodiment shown in FIG. 1, further description is omitted.

The tube member 14 is a resin-made tube (e.g., inner diameter: 0.6 mm; outer diameter: 1.3 mm; length: 5 mm) and one end thereof is fitted into an opening section 12a formed in the shell 12 and disposed along a vent port 18. The opening section 12a is a through-hole for establishing communication between the inside of the case body 13 and the outer world. Another end of the tube member 14 is affixed to the guide groove 15 (e.g., semi-circular shape in section with a radius of about 0.5 mm) formed along the vent port 18 on the inner wall surface of the shell 12. One end of the tube member 14 is trimmed to copy the surface shape of the shell 12.

The pull-out type linear member 16 is a resin-made linear member with a diameter of about 0.5 mm and is provided at both ends with small bulges 16a and 16b. The pull-out type linear member 16 is inserted into the tube member 14 before the face plate 11 is affixed to the shell 12. The outer diameter of the small bulges 16a and 16b is larger than the inner diameter of the tube member 14 to prevent the pull-out type linear member 16 from coming off the tube member 14. The tube member 14 also serves as a stopper for the small bulge 16a.

In order to insert the pull-out type linear member 16 into the tube member 14, the linear member is first inserted into the tube member 14 attached to the shell 12 through the opening section 12a side of the shell 12 to project from the other end of the tube member 14. The projected end section of the linear member is melted by a soldering iron to form the small bulge 16a and then the linear member is pulled until the small bulge 16a touches the other end of the tube member 14. In a condition in which the small lump 16a touches the other end of the tube member 14, the linear member is cut in a desired length, wherein a bead is affixed to the cut end to form the small bulge 16b. The length of the pull-out type linear member 16 is determined so that the small bulge 16a does not contact an instrument such as an earphone when the pull-out type linear member 16 is pushed into the tube member 14.

By providing such a pull-out type linear member 16, when the in-the-ear hearing aid is not used, the pull-out type linear member 16 is brought into a projecting condition, wherein the entire in-the-ear hearing aid can be held by gripping the pull-out type linear member 16 with the fingertips. This makes removal operation of the hearing aid easier. When the hearing aid is used, the pull-out type linear member 16 is pushed into the tube member 14 for housing. In this manner, the pull-out type linear member 16 is hidden from the eyes of an onlooker and as a result, the hearing aid has an attractive appearance.

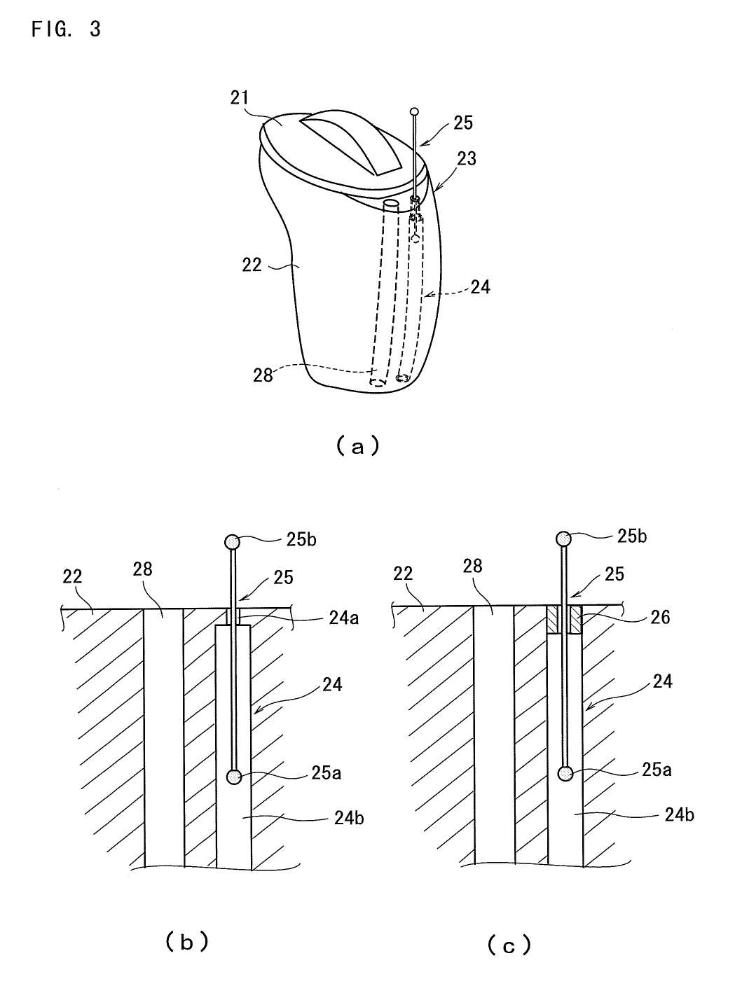

A third embodiment of the in-the-ear hearing aid according to the present invention is shown in FIG. 3. A case body 23 is composed of a face plate 21 and a shell 22. A guide tunnel 24 is provided to penetrate a wall section 22a of the shell 22. A pull-out type linear member 25 is inserted into the guide tunnel 24. The face plate 21 and the shell 22 are joined to form the case body 23, but in the case where instruments such as a microphone and an amplifier housed within the case body 23 are repaired, the face plate 21 can be removed from the shell 22. Since parts other than the shell 22 and a housing section are the same as in the first embodiment shown in FIG. 1, further description is omitted.

The guide tunnel 24 is composed, as shown in FIG. 3(b), of a small diameter port 24a and a large diameter port 24b opened on the face plate 21-side and is provided along a vent port 28. As shown in FIG. 3(c), the guide tunnel 24 can be composed of the large diameter port 24b only, wherein a resin tube (e.g., inner diameter: about 1 mm, length: about 3 mm) is inserted into the large diameter port 24b so that the opening on the face plate 21 side can have the same inner diameter as the small diameter port 24a. The pull-out type linear member 25 is a resin-made linear member with a diameter of about 0.5 mm and is provided at both ends with small bulges 25a and 25b. The pull-out type linear member 25 can be inserted into the guide tunnel 24 even after the face plate 21 is affixed to the shell 22. The outer diameter of the small lumps 25a and 25b is larger than the inner diameter of the small diameter port 24a or the resin tube 26 to prevent the pull-out type linear member 25 from coming off the guide tunnel 24. The small diameter port 24a and the resin tube 26 serve as a stopper for the small bulge 25a.

In order to insert the pull-out type linear member 25 into the guide tunnel 24, the linear member is first inserted through the small diameter port 24a side to project from the large diameter port 24b. A projected end section of the linear member is melted by a soldering iron to form the small bulge 25a which is larger than the inner diameter of the small diameter port 24a. Then, the linear member is pulled until the small lump 25a touches an end of the small diameter port 24a. In a condition in which the small lump 25a touches the end of the small lump 24a, the linear member is cut in a desired length. A bead is then affixed to the cut end of the linear member to form the small lump 25b. The length of the pull-out type linear member 25 is determined so that the small bulge 25a does not project from the guide tunnel 24 when the pull-out type linear member 25 is pushed into the guide tunnel 24.

With the provision of such a pull-out type linear member 25, when the in-the-ear hearing aid is not used, the pull-out type linear member is brought into a projecting condition, wherein the entire hearing aid can be held by gripping the pull-out type linear member 25 with the fingertips. This makes the detaching operation of the hearing aid easier. When the hearing aid is used, the pull-out type linear member 25 is pushed into the guide tunnel 24 for housing. Since the pull-out type linear member 25 is hidden from the eyes of an onlooker, the hearing aid has an attractive appearance.

Since the pull-out type linear member 25 is not housed within the case body 23, it is not necessary to remove the face plate 21 from the shell 22. Thus, replacement of the pull-out type linear member 25 can be readily conducted.

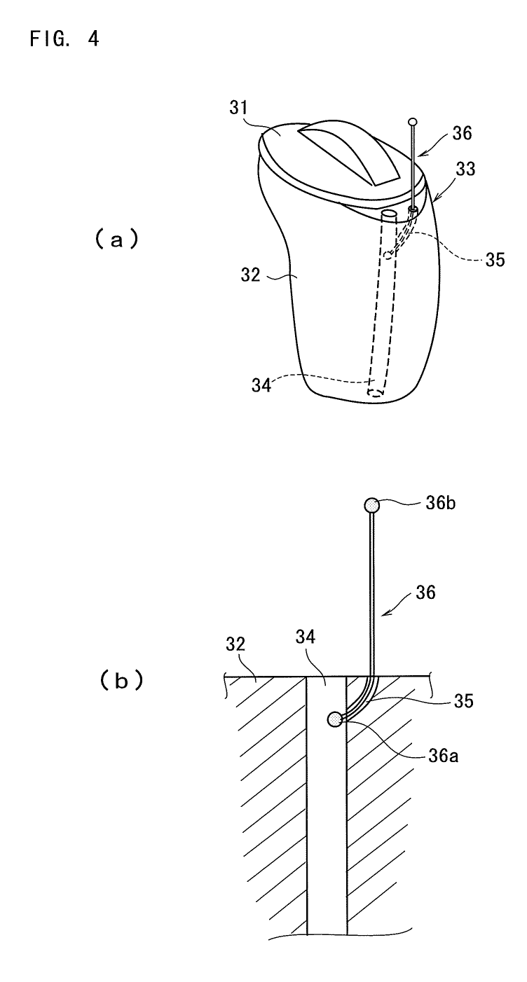

Referring to a fourth embodiment of the in-the-ear hearing aid according to the present invention, a case body 33 is composed, as shown in FIG. 4, of a face plate 31 and a shell 32. A guide tunnel 35 is provided on a wall section 32a of the shell 32 to communicate with a vent port 34. A pull-out type linear member 36 is inserted into the guide tunnel 35 and part of the vent port 34. The face plate 31 and the shell 32 are joined to form the case body 33, but in the case where instruments such as a microphone and an amplifier housed within the case body 33 are repaired, the face plate 31 can be removed from the shell 32. Since parts other than the shell 32 and a housing section are the same as in the first embodiment shown in FIG. 1, further description is omitted.

The guide tunnel 35 with an inner diameter of about 1 mm diverges at a slant from the vent port 34 to open on the face plate 31-side. The pull-out type linear member 36 is a resin-made linear member with a diameter of about 0.5 mm and is provided at both ends with small bulges 36a and 36b. The pull-out type linear member 36 can be inserted into the guide tunnel 35 and part of the vent port 34 even after the face plate 31 is affixed to the shell 32. The outer diameter of the small bulges 36a and 36b is larger than the inner diameter of the guide tunnel 35 to prevent the pull-out type linear member 36 from coming off the guide tunnel 35. The guide tunnel 35 also serves as a stopper for the small bulge 36a.

In order to insert the pull-out type linear member 36 into the guide tunnel 35, the linear member is first inserted through the face plate 31-side opening of the guide tunnel 35 to project from the side of the vent port 34 opposite to the face plate 31. An end of the projected linear member is melted by a soldering iron to form the small bulge 36a which is larger than the inner diameter of the guide tunnel 35. The linear member is then pulled until the small bulge 36a touches the end section of the guide tunnel 35. In a condition in which the small bulge 36a touches the end section of the guide tunnel 35, the linear member is cut in a desired length, wherein a bead is affixed to the cut end of the linear member to form the small bulge 36b. The length of the pull-out type linear member 36 is determined so that the small bulge 36a does not project from the vent port 34 when the pull-out type linear member 36 is pushed into the guide tunnel 35 and the vent port 34.

With the provision of such a pull-out type linear member 36, when the in-the-ear hearing aid is not used, in other words, when the hearing aid is detached from the external auditory canal, the pull-out type linear member is brought into a projecting condition, wherein the entire hearing aid can be held by gripping the pull-out type linear member 36 by the fingertips. This makes the detaching operation of the hearing aid easy. On the other hand, when the hearing aid is used, the pull-out type linear member 36 is pushed into the guide tunnel 35 and the vent port 34 for housing. In this manner, the hearing aid has an attractive appearance because the pull-out type linear member 36 is hidden from the eyes of an onlooker. Since the pull-out type linear member 36 is not housed within the case body 33, it is not necessary to remove the face plate 31 from the shell 32 and thus, replacement of the pull-out type linear member 36 can be readily conducted.

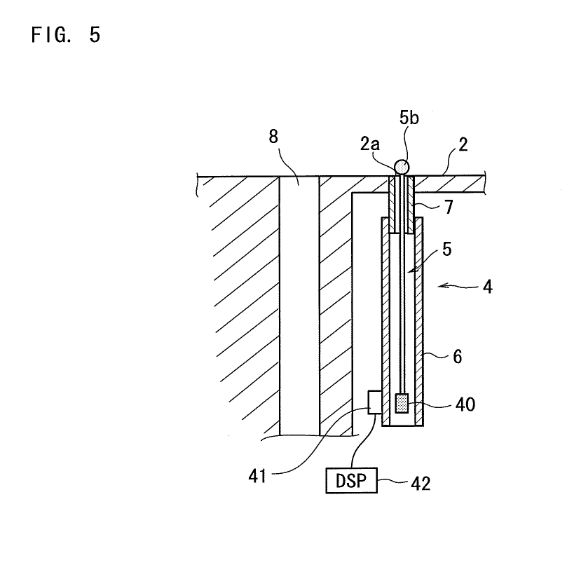

FIG. 5 shows a fifth embodiment of the in-the-ear hearing aid according to the present invention. A magnet 40 in place of the small bulge 5a used in the first embodiment is attached to a linear member. A hall element 41 is disposed on the outer wall of the larger diameter resin tube 6 and an output from the hall element 41 is wired to a DSP 42. The hall element 41 is disposed on the outer wall of the large diameter resin tube 6 near the position where the magnet 40 is fully retracted when the small bulge 5b touches the opening section 2a.

Likewise, in the second embodiment, the magnet 40 in place of the small bulge 16a is attached to the linear member, wherein the hall element 41 can be disposed on the inner wall of the shell 12 alongside the guide groove 15 near the position where the magnet 40 is fully retracted to wire the output from the hall element 41 to the DSP 42. Further, in the third embodiment, the magnet 40 in place of the small bulge 25a is attached to the linear member, wherein the hall element 41 can be disposed on the inner wall of the shell 22 near the fully retracted position of the magnet to wire the output from the hall element 41 to the DSP 42. Still further, in the fourth embodiment, the magnet 40 in place of the small bulge 36a is attached to the linear member, wherein the hall element 41 can be disposed on the inner wall of the shell 32 near the fully retracted position of the magnet 40 to wire the output from the hall element 41 to the DSP 42.

With this arrangement, the pull-out type linear members 5, 16, 25 and 36 can be used as a switch. For example, if the hall element 41 is provided so that the magnet 40 comes close when the pull-out type linear members 5, 16, 25 and 36 are housed and the power of the in-the-ear hearing aid is turned ON by the output signal from the hall element 41, the pull-out type linear members 5, 16, 25 and 36 are the power switch and the power of the hearing aid can be readily turned ON while using.

Further, if an output signal from the hall element 41 is used for a switch for changing-over the set memory of the in-the-ear hearing aid, changeover of the set memory can be readily conducted by the pull-in and pull-out condition or the pull-in and pull-out operation of the pull-out type linear members 5, 16, 25 and 36. The hall element 41 can also be located in a position close to the magnet 40 when the pull-out type linear members 5, 16, 25 and 36 are pulled out.

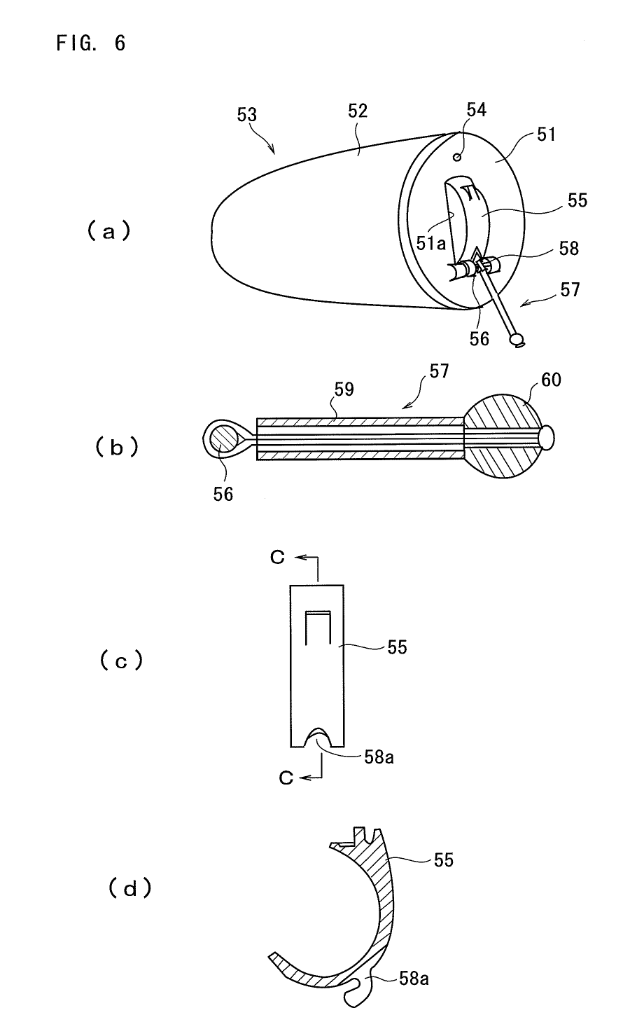

A sixth embodiment of the in-the-ear hearing aid according to the present invention is shown in FIG. 6. A case body 53 is composed of a face plate 51 and a shell 52. The face plate 51 is provided with a through-hole 54 for installing a microphone, a battery holder 55, a rotational axis 56 for opening and closing the battery holder 55, and a pull-out type linear member 57. Housed within the case body 53 are an amplifier or a DSP, an earphone, and a button battery (not shown).

The face plate 51 is provided with an opening section 51a for installing the battery holder 55. The rotational axis 56 is provided at a region of the opening section 51a on the lower side of the external auditory canal. The battery holder 55 is adapted to open and close around the rotational axis 56 in a rotary manner. The battery holder 55 engages the rotational axis 56 through a hook 58. The hook 58 is formed with a notched section 58a with a width of about 1 mm to expose the rotational axis 56. The notched section 58a can be located in the center of or on the right or left side of the hook 58. The position of the notched section 58a is provided with a groove with a depth of about 0.5 mm corresponding to the width of the notched section 58a. The battery holder 55 is detachably provided relative to the rotational axis 56.

A resin-made linear member (such as nylon system and PE line) with a diameter of about 0.5 mm is used for the pull-out type linear member 57. The pull-out type linear member 57 is constructed as described below. In a condition in which the battery holder 55 is removed from the face plate 51, the linear member is wrapped around the rotational axis 56 (one roll) to have a desired length. Then, both ends of the linear member are bound up and are inserted into a resin tube 59. The linear member projecting from the resin tube 59 is inserted into a bead 60, wherein the end section of the linear member is affixed to the bead 60. Finally, the battery holder 55 is installed so that the notched section 58a meets the section where the linear member has been wrapped (one roll) around the rotational axis 56.

Since a flexible material is used for the linear member, the range of choice for the materials can be broadened. The colors of the linear member and the length of the resin tube 59 can be adjusted depending upon the taste of the user. A jewel can also be used in place of the bead 60.

With the provision of such a pull-out type linear member 57, the pull-out type linear member 57 droops and can be decorated to suit the user's taste. In this manner, the pull-out type linear member 57 is not projected unnaturally from the external auditory canal, but it is possible to make active use of the pull-out type linear member 57 as a kind of accessory. Even in the case where the pull-out type linear member is damaged, it can be repaired in the same manner as a production process and as a result, replacement of the pull-out type linear member 57 can be readily conducted.

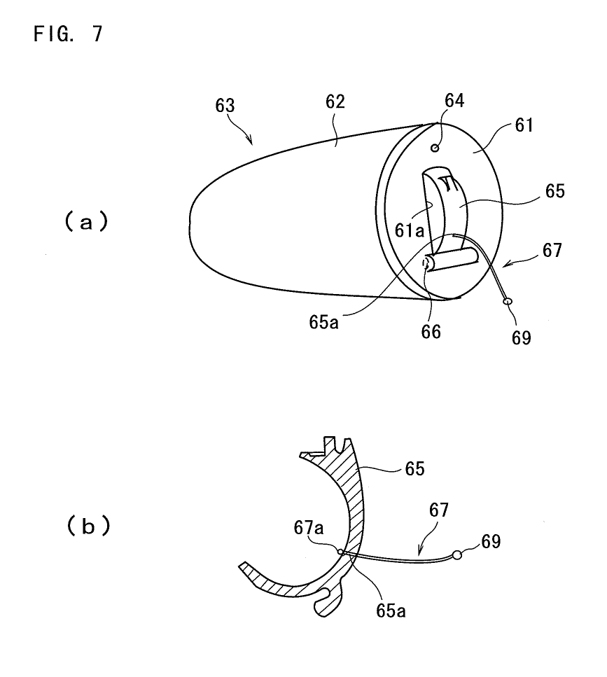

A seventh embodiment of the in-the-ear hearing aid according to the present invention is shown in FIG. 7. A case body 63 is composed of a face plate 61 and a shell 62. The face plate 61 is provided with a through-hole 64 for installing a microphone, a battery holder 65, a rotational axis 66 for opening and closing the battery holder 65, and a pull-out type linear member 67.

The face plate 61 is provided with an opening section 61a for installing the battery holder 65. The rotational axis 66 is provided at a region of the opening section 61a on the lower side of the external auditory canal. The battery holder 65 is adapted to open and close around the rotational axis 66 in a rotary manner.

A resin-made linear member (such as nylon system and PE line) with a diameter of about 0.5 mm is used for the pull-out type linear member 67. The pull-out type linear member 67 is constructed as described below. First, a through-hole 65a with a diameter of about 0.5 mm is formed on the outer peripheral surface of the battery holder 65. A resin-made linear member with a diameter of about 0.4 mm is inserted into the through-hole 65a, wherein an end section of the resin-made linear member within the battery holder 65 is melted by a soldering iron to form a small bulge 67a. Then, the resin-made linear member is pulled until the small bulge 67a touches the inner peripheral surface of the battery holder 65. In this condition, the small bulge 67a is affixed to the inner peripheral surface of the battery holder 65. The resin-made linear member is then cut to suit the user's taste and the end section is inserted into a bead 69 for adhesion. A jewel can be used in place of the bead 69.

By providing such a pull-out type linear member 67, the pull-out type linear member 67 droops down and can be decorated to suit the user's taste. In this manner, the pull-out type linear member 67 does not project unnaturally from the external auditory canal, but it can be effectively utilized as a kind of accessory. Further, the battery holder 65 is opened by pulling the pull-out type linear member 67 while holding the hearing aid with the fingertips. This makes the removal of a button battery easy. Even in the case where the pull-out type linear member 67 is damaged, only the battery holder 65 with the pull-out type linear member 67 is replaced. This makes the repair work easy.

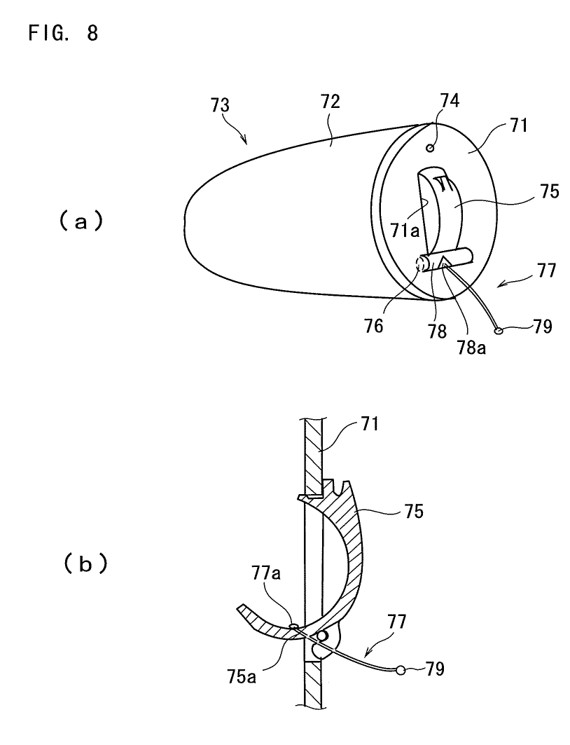

Referring to an eighth embodiment of the in-the-ear hearing aid according to the present invention, a case body 73 is composed, as shown in FIG. 8, of a face plate 71 and a shell 72. The face plate 71 is provided with a through-hole 74 for installing a microphone, a battery holder 75, a rotational axis 76 for opening and closing the battery holder 75, and a pull-out type linear member 77.

The face plate 71 is also provided with an opening section 71a for installing the battery holder 75. The rotational axis 76 is fitted into a region of the opening section 71a on the lower side of the external auditory canal. The battery holder 75 is adapted to open and close around the rotational axis 76 in a rotary manner. The battery holder 75 engages the rotational axis 76 through a hook 78. The hook 78 is formed with a notched section 78a with a width of about 1 mm to expose the rotational axis 76. The notched section 78a can be located in the center of or on the right or left side of the hook 78. The battery holder 75 is detachably mounted relative to the rotational axis 76.

A resin-made linear member (such as nylon system and PE line) with a diameter of about 0.5 mm is used for the pull-out type linear member 77. The pull-out type linear member 77 is constructed as described below. First, in a condition in which the battery holder 75 is removed from the face plate 71, a through-hole 75a with a diameter of about 0.5 mm is provided on the outer peripheral surface of the battery holder 75 in the vicinity of the hook 78 at an end section of the battery holder 75. Then, a resin-made linear member with a diameter of about 0.4 mm is inserted into the through-hole 75a to form a small bulge 77a at an end section of the resin-made linear member within the battery holder 75.

The resin-made linear member is pulled until the small bulge 77a touches the inner peripheral surface of the battery holder 75. In this condition, the small bulge 77a adheres to the inner peripheral surface of the battery holder 75. The resin-made linear member is cut in the user's desired length (e.g., about 20 mm). In this condition, the battery holder 75 is mounted on the rotational axis 76. When mounting the battery holder 75 on the rotational axis 76, the resin-made linear member is pulled outside through the notched section 78a of the hook 78. A bead 79 is affixed to the end section of the resin-made linear member. A jewel can also be used in place of the bead 79. Since a flexible material can be used for the linear member and the range of choice for the materials is broadened, it is possible to freely select the color and length of the linear member.

With the provision of such a pull-out type linear member 77, the battery holder 76 is closed by pulling the pull-out type linear member 77 while holding the hearing aid with the fingertips. If a harder linear member is used, the battery holder 75 is opened by pushing the pull-out type linear member inside. Thus, at replacement operation of a button battery can be readily conducted. Further, even in the case where the pull-out type linear member is damaged, only the battery holder 75 with the pull-out type linear member 77 is replaced. This makes the repair work easy. Further, even in the case where the linear member is replaced, it is not necessary to detach the face plate 71 from the shell 72.

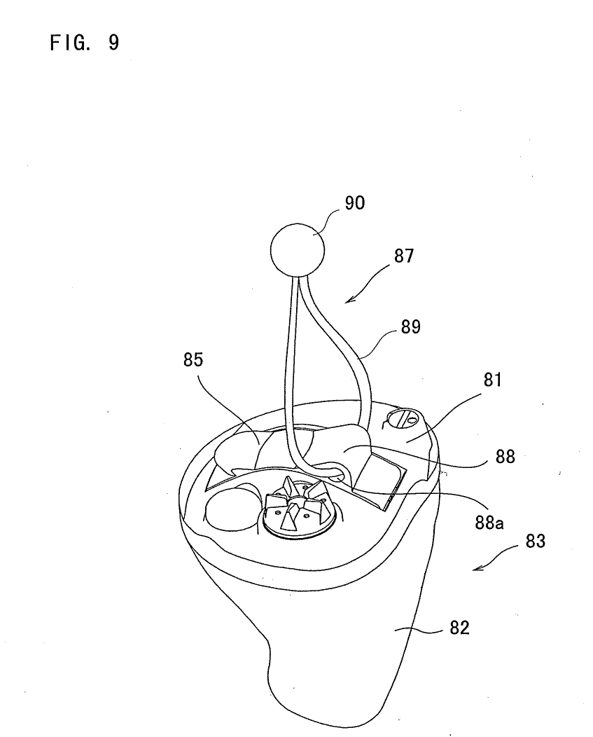

A ninth embodiment of the in-the-ear hearing aid according to the present invention is shown in FIG. 9. A case body 83 is composed of a face plate 81 and a shell 82. The face plate 81 is provided with a battery holder 85. Referring to a pull-out type linear member 87, a resin-made linear member 89 is inserted into a through-hole 88a penetrating a protrusion 88 of a battery holder 85 to have a desired length. After both ends of the resin-made linear member 89 are aligned, the ends are affixed to a bead 90.

With the provision of such a pull-out type linear member 87, a flexible material can be used for the linear member and the range of choice for materials can be broadened. If the pull-out type linear member 87 is colored and its end is decorated with a jewel, an aesthetic effect as an accessory can be provided and there is no artificiality whereby the pull-out type linear member 87 is seen to be protruding from the external auditory canal. Since the battery holder 85 is opened by pulling the pull-out type linear member 87 while holding the hearing aid with the fingertips, this makes removal of the button battery easy. Further, even in the case where the pull-out type linear member 87 is damaged, only the battery holder 85 with the pull-out type linear holder 87 is replaced and a repairing operation can be readily conducted. Even when the linear member is replaced, it is possible to do repairs without detaching the face plate 81 from the shell 82.

### EFFECTS OF THE INVENTION

As described above, according to first through third aspects of the present invention, a housing section is provided to house a pull-out type linear member. Thus, the pull-out type linear member is not too obvious and does not attract people's attention. Further, user-friendliness improves and an unpleasant feeling is not produced because the pull-out type linear member does not touch the auricle of the ear during use of the hearing aid.

According to the fourth and fifth aspects of the present invention, the housing section does not exist in a case body, but is composed of a guide tunnel penetrating the case body or a guide tunnel formed in the case body and a vent port adapted to communicate with the guide tunnel. In this manner, it is not necessary to remove the face plate adhering to a shell and as a result, replacement of the pull-out type linear member can be readily conducted.

According to the sixth aspect of the present invention, the pull-out type linear member can be pulled in or pulled out without restraint and it is not pulled out beyond a predetermined length. In this manner, it is possible to hold the in-the-ear hearing aid itself by holding the pull-out type linear member. Further, movement of the pull-out type linear member becomes smooth and maneuverability improves.

According to the seventh aspect of the present invention, a rear small bulge is made of a magnetic member and a hall element is disposed in the vicinity of the housing section. For example, by disposing the hall element in the vicinity of a step-back position of a magnetic member in which a small front bulge comes into contact with a stopper section, it is possible to allow the magnetic member to have a function such as a power switch or a function changing switch. If the hall element is used as the power switch, the power of the hearing aid is turned ON by housing the pull-out type linear member after completely fitting the hearing aid into the external auditory canal. In this manner, feedback during the fitting operation is not generated. Further, when the pull-out type linear member is pulled out, the power is automatically turned OFF. In this manner, feedback during the removal operation is not generated and unnecessary power is not consumed during removal of the hearing aid.

According to the eighth aspect of the present invention, since a flexible material can be used for the linear member, the range of options for the material is broadened. For example, if the pull-out type linear member is colored and its end is decorated with a jewel, it can exert an aesthetic effect as an accessory and there is no artificiality whereby the pull-out type linear member is seen to be protruding from the external auditory canal. It is also possible to repair the linear member without removing the face plate. Since a battery holder is generally a replaceable part, if the battery holder is provided with the pull-out type linear member, even though the pull-out type linear member is damaged, the battery holder can be replaced as an integral unit. Since the battery holder can be opened simply by pulling the pull-out type linear member, it becomes easier to open the small battery holder and battery replacement can also be readily conducted.

According to the ninth aspect of the present invention, since the linear member is mounted on a rotational axis with which the openable and closable battery holder is adapted to engage to serve as the pull-out type linear member, the pull-out type linear member can be repaired without removing the face plate and as a result, repair service can also be conducted over the counter. Further, since a flexible material can be used for the linear member, the range of options for materials is broadened. For example, if the pull-out type linear member is colored and its end is decorated with a jewel, it can exert an aesthetic effect as an accessory and there is no artificiality whereby the pull-out type linear member is seen to be protruding from the external auditory canal.

### INDUSTRIAL APPLICABILITY

According to the present invention, since it is possible to provide an in-the-ear hearing aid which has an attractive appearance when fitted and of which the pull-out type linear member can be readily repaired and replaced, this can contribute to the expansion in demand for the in-the-ear hearing aid.

What is claimed is:

1. An in-the-ear hearing aid provided with a pull-out type linear member, characterized in that a housing section is provided to house the pull-out type linear member.

2. The in-the-ear hearing aid according to claim 1, wherein the housing section is a tube member disposed within a case body.

3. The in-the-ear hearing aid according to claim 1, wherein the housing section is the tube member disposed within the case body and a guide groove formed on the inner wall surface of the case body.

4. The in-the-ear hearing aid according to claim 1, wherein the housing section is a guide tunnel penetrating the case body.

5. The in-the-ear hearing aid according to claim 1, wherein the housing section is the guide tunnel formed in the case body and a vent port adapted to communicate with the guide tunnel.

6. The in-the-ear hearing aid according to claim 1, wherein the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

7. The in-the-ear hearing aid according to claim 6, wherein the rear small bulge is composed of a magnetic member and a hall element is provided in the vicinity of the housing section.

8. An in-the-ear hearing aid provided with a pull-out type linear member, characterized in that the pull-out type linear member is fitted into an openable and closable battery holder.

9. An in-the-ear hearing aid provided with a pull-out type linear member, characterized in that the pull-out type linear member is mounted on a rotational axis with which the openable and closable battery holder is engaged.

10. The in-the-ear hearing aid according to claim 2, wherein the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

11. The in-the-ear hearing aid according to claim 3, wherein the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

12. The in-the-ear hearing aid according to claim 4, wherein the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

13. The in-the-ear hearing aid according to claim 5, wherein the pull-out type linear member is provided at both ends with small bulges, the pull-out type linear member is provided in such a manner that the front small bulge is located outside the housing section and the rear small bulge is located inside the housing section, and a stopper for the rear small bulge is provided at an opening section of the housing section.

14. The in-the-ear hearing aid according to claim 10, wherein the rear small bulge is composed of a magnetic member and a hall element is provided in the vicinity of the housing section.

15. The in-the-ear hearing aid according to claim 11, wherein the rear small bulge is composed of a magnetic member and a hall element is provided in the vicinity of the housing section.

16. The in-the-ear hearing aid according to claim 12, wherein the rear small bulge is composed of a magnetic member and a hall element is provided in the vicinity of the housing section.

17. The in-the-ear hearing aid according to claim 13, wherein the rear small bulge is composed of a magnetic member and a hall element is provided in the vicinity of the housing section.
